(19) United States
(12) Patent Application Publication
(10) Pub. No.: US 2017/0148324 A1
(43) Pub. Date: May 25, 2017

(54) Navigating a Customer to a Parking Space

(71) Applicant: Wal-Mart Stores, Inc., Bentonville, AR (US)

(72) Inventors: Donald High, Noel, MO (US); David Eugene Ferrell, Rogers, AR (US); Michael Dean Atchley, Springdale, AR (US)

(21) Appl. No.: 15/355,801

(22) Filed: Nov. 18, 2016

Related U.S. Application Data
(60) Provisional application No. 62/258,812, filed on Nov. 23, 2015.

(51) Int. Cl. G08G 1/14; G08G 1/0969; H04W 4/02

(52) U.S. Cl. CPC G08G 1/144; H04W 4/02; G08G 1/0969; G08G 1/143

(57) ABSTRACT

The present invention extends to methods, systems, and computer program products for navigating a customer to a parking space. A customer sends a request from a mobile device or vehicle navigation system for directions to a parking space in a store parking lot. A store computer receives the customer request along with parking requests from other customers. The store computer identifies appropriate candidate parking spaces utilizing camera systems, sensor systems, location of customer mobile devices, and point-of-sale (POS) activity. The store computer identifies the candidate spaces for each customer based on their proximity to the store and their parking preferences. The store computer transmits navigation instructions to parking spaces via the customer mobile devices and/or the vehicle navigation systems. The parking space is stored in the customer mobile device and is used by the customer upon exiting the store for navigation instructions back to the customer parking space.

### CROSS-REFERENCE TO RELATED APPLICATIONS

This application claims the benefit of U.S. Provisional Patent Application 62/258,812 filed Nov. 23, 2015, and titled “Navigating a Customer to a Parking Space”, the entire contents of which are hereby incorporated herein by reference.

### BACKGROUND

1. Field of the Invention

This invention relates generally to the field of parking navigation, and, more particularly, to navigating a customer to a parking space utilizing mobile devices and parking lot sensors.

2. Related Art

Finding a parking space at a store or club can be an unpleasant experience. Trying to find a convenient space (e.g. close to the store entrance) may require the driver to waste valuable time driving up one aisle and down the next until an available space is identified. Finding optimal parking spaces becomes even more important during inclement weather, such as rain or snow, or in the cases where customers are purchasing or need to return something that is heavy or awkward.

Driving up and down parking aisles increases vehicle congestion in the parking lot and increases the risk of an accident, either with another vehicle or possibly with a pedestrian. Even though a vehicle may be travelling at slow speeds, the driver's attention may be focused on identifying candidate parking spaces rather than focusing on safely navigating his/her vehicle through the parking lot.

Once a parking space is identified, it may not be in the best location for a customer. For example, it may not be near the entrance in closest proximity to the items on the customer's shopping list. Also, there may be other available spaces that are in a better location but the customer is unware of the other available spaces.

Additionally, as a customer exits a store, it may be difficult to remember where the customer's vehicle is parked. A customer will typically spend some amount of time searching for their parking location. This can be especially problematic when the customer is laden with heavy bags or young children that may be prone to wander in front of moving vehicles.

These parking difficulties and inconveniences may result in a negative customer experience or possibly in a dangerous situation where an accident may occur. Over time, if locating a parking space continues to be problematic for a customer, the customer may decide to stop shopping at that store location altogether.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example computer architecture that facilitates navigating a customer to a parking space.

FIG. 3 illustrates a flow chart of an example method for navigating a customer to a parking space.

FIG. 4 illustrates an example parking navigation scenario.

### DETAILED DESCRIPTION

The present invention extends to methods, systems, and computer program products for navigating a customer to a parking space. In the following description of the present invention, reference is made to the accompanying drawings, which form a part hereof, and in which is shown by way of illustration specific embodiments in which the invention may be practiced. It is understood that other embodiments may be utilized and structural changes may be made without departing from the scope of the present invention.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (SaaS), Platform as a Service (PaaS), Infrastructure as a Service (IaaS), and deployment models (e.g., private cloud, community cloud, public cloud, hybrid cloud, etc.). Databases and servers described with respect to the present invention can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

In general, aspects of the invention are directed to navigating a customer to a parking space in a parking lot. A customer initiates a parking request for a parking space via his/her mobile device. Alternatively, the customer can initiate a parking request through a vehicle navigation system. The parking request is sent to a central computer system. The central computer system (which may or may not be on premise at the store and may or may not be owned by the store) receives the parking request from the mobile device (or vehicle navigation system). The central computer system refers to various different types of data (e.g., customer preferences, parking lot maps, parking lot sensor data, point-of-sale (POS) data, etc.) to identify one or more candidate parking spaces for the customer. The central computer system returns directions to the one or more candidate parking spaces back to the mobile device (or vehicle navigation system). Accordingly, a customer mobile device (or vehicle navigation system), the central computer system, and sensory devices located in the store and in the store parking lot can interoperate with one another to facilitate the identification of one or more candidate parking spaces and provide navigation directions to the one or more candidate parking spaces.

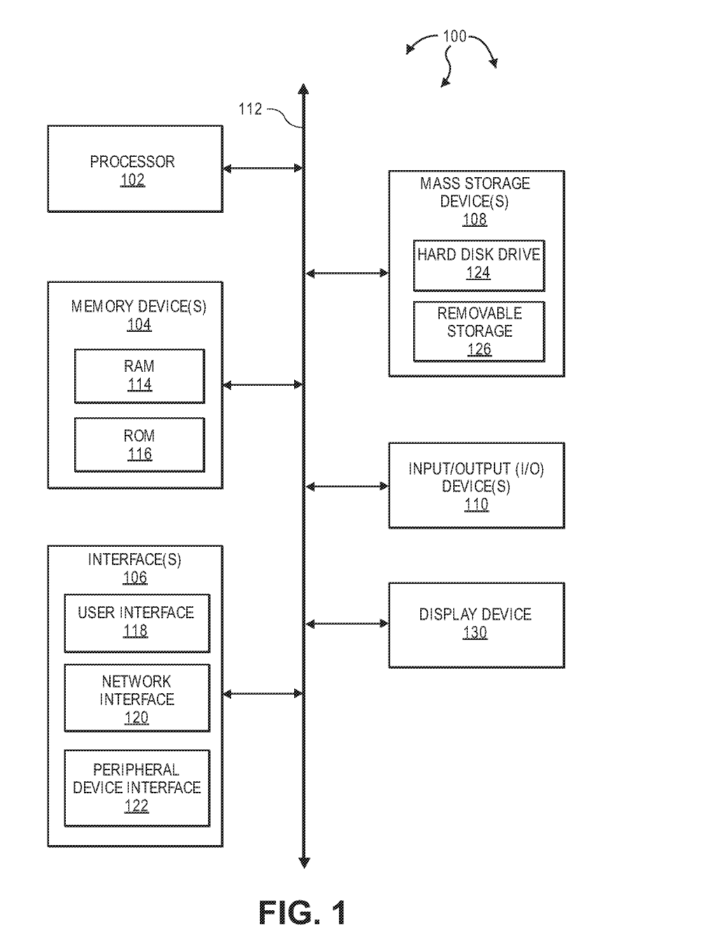

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc., networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

In general, parking navigation enables a person to navigate to an appropriate parking space as they arrive at a store location parking lot and enables a person to find their way back to their vehicle in the store location parking lot when they exit the store location. A central computer system (either located on premise or remotely) can use various types of data accessed from databases, parking lot sensors, in-store sensors, positions of customers utilizing their mobile devices, etc. to identify candidate parking spaces for customers. For example, to identify candidate parking spaces, a central computer system can utilize one or more of: customer location at the time a parking request is initiated, customer preferences and/or a customer shopping list (e.g., received with the parking request or accessed from a database), images from parking lot cameras, sensed data from other parking lot sensors (e.g., pavement sensors), Point-Of-Sale (POS) data (e.g., an indication of customer's checking out or about to checkout), etc. When a customer exits a store location, the central computer system can also provide directions to the customer's parking space to the customer's mobile device.

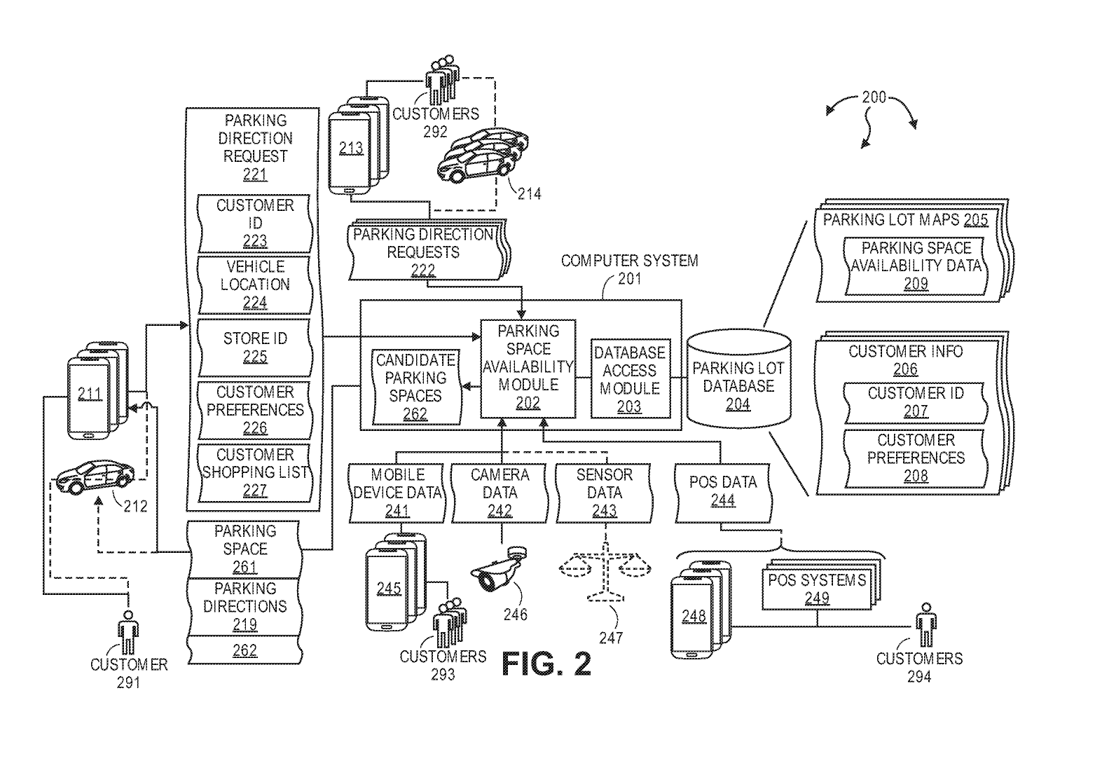

FIG. 2 illustrates an example computer architecture 200 that facilitates navigating a customer to a parking space. Referring to FIG. 2, computer architecture includes computer system 201, parking lot database 204, mobile device 211 (e.g. a smartphone), mobile devices 213, mobile devices 245, mobile devices 248, camera system 246, and point-of-sale (POS) terminals 249. In some embodiments, computer architecture 200 also includes one or more of: vehicle navigation system 212, vehicle navigation systems 214, and parking sensor system 247. Each of the depicted components can be connected to one another over (or be part of) a network, such as, for example, a PAN, a LAN, a WAN, and even the Internet. Accordingly, each of the depicted components, as well as any other connected computer systems and their components, can create message related data and exchange message related data (e.g., near field communication (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network.

As depicted, computer system 201 further includes parking space availability module 202 and database access module 203. Generally, parking space availability module 202 can utilize database access module 203 to store and access parking lot maps and customer information in parking lot database 204. Each parking lot map can be a layout of a parking lot for a given store location. The layout can include such detail as the number of parking spaces, the location of parking spaces relative to adjacent streets, the location of parking spaces relative to the store location entrances, the location of specialized parking spaces, such as, for example handicapped spaces, compact vehicle spaces, wide vehicle spaces, and/or RV parking spaces. Each parking lot map can also numerically identify each parking space. Numerical identification can correspond to parking space location within a parking lot.

Customer information stored in parking lot database 204 can include customer parking preferences, historical parking information for the customer, an indication of a currently occupied parking space, etc.

Parking space availability module 202 can be configured to execute parking navigation related operations, such as, for example, receive parking requests from customer mobile devices and/or vehicle navigation systems for parking spaces. For example, customer 291, may utilize his/her mobile device 211, or in some embodiments, his/her vehicle navigation system 212 to issue a request for a parking space at a particular store location. Concurrently, other customers 292 can utilize their mobile devices 213, and in some embodiments, their vehicle navigation systems 214, to also issue requests for parking spaces at the particular store location or at one or more other different store locations. Parking space availability module 202 can be configured to receive the various parking requests and estimate the times when each customer is to arrive at a store location parking lot. For each store location, the parking requests can then be entered into a queue based on the estimated arrival times. Parking requests can be made utilizing wireless technology, cell phone technology, blue tooth technology, Radio Frequency Identification (RFID) technology, and the like.

Parking space availability module 202 can be configured to identify candidate parking spaces that are either currently available or are to become available within a specified period of time. Parking space availability module can utilize information contained in parking lot database 204 in view of customer estimated arrival times at a store location and estimated checkout times for customers in the store location. For example, parking space availability module 202 can update the status (e.g., occupied or unoccupied) of parking spaces tracked in parking lot database 204. Parking space availability module 202 can update parking space status by utilizing imagery from camera system 246, utilizing the location and movement of customers 293 based location of their mobile devices 245, and in some embodiments, by using other sensor systems 247 which can detect the presence of vehicles in the parking lot parking spaces.

Parking space availability module 202 can determine, based on the congestion of the parking lot, whether the store location is busier or less busy than normal operating conditions. Parking space availability module 202 can provide an indication back to a requesting customer regarding how busy a particular store location is. For example, parking space availability module 202 can indicate to the customer that a store location parking lot is 25% full and thus it is a good time to visit the store location.

Parking space availability module 202 can also be configured to utilize point-of-sale (POS) data to estimate when customers 294 are likely to be returning to their vehicles and leaving the parking lot. Parking space availability module 202 can utilize the location and movement of mobile devices 248 and/or customer activity at POS systems 249 to update parking lot database 204. The location and movement of mobile devices 248 and the activity at POS systems 249 can indicate that customers 294 are in the checkout process and are likely to be returning to their vehicles in a specified amount of time.

Parking space availability module 202 can also utilize the POS data for a store location to provide information to customers requesting parking spaces at the store location. POS data can be used to indicate approximate wait times at the POS locations, to indicate POS locations that are processing customers more quickly than other POS locations, and to indicate if a customer's chosen time to visit the store location is an appropriate time based on the activity at the POS systems and customer preferences. For example, if a customer submits a parking request for a parking space at a store location, and the store location is experiencing higher than usual customer volumes or higher than usual POS wait times, parking space availability module 202 can indicate to the customer that he or she may experience higher than usual wait times for a parking space. As such, the customer may want to wait until volume at the store location has reduced or travel to another nearby store location with more reasonable parking space availability.

Parking space availability module 202 is also configured to provide customers with directions to their parking spaces, both when entering a parking lot and when exiting a store location. Directions can be provided to customer mobile devices and, in some embodiments, also to the customer vehicle navigation systems. For example, parking space availability module 202 can query parking lot database 204 via database access module 203 to identify a parking space selected by a user or a parking space where a customer previously parked their car. Parking space availability module 202 can access a parking lot map from database 204. Parking space availability module 202 can provide an image of the parking lot map along with directions to the identified parking space to a customer mobile device (and/or vehicle navigation system). The customer can then utilize the provided directions to navigate (either their vehicle or themselves) to the identified parking space.

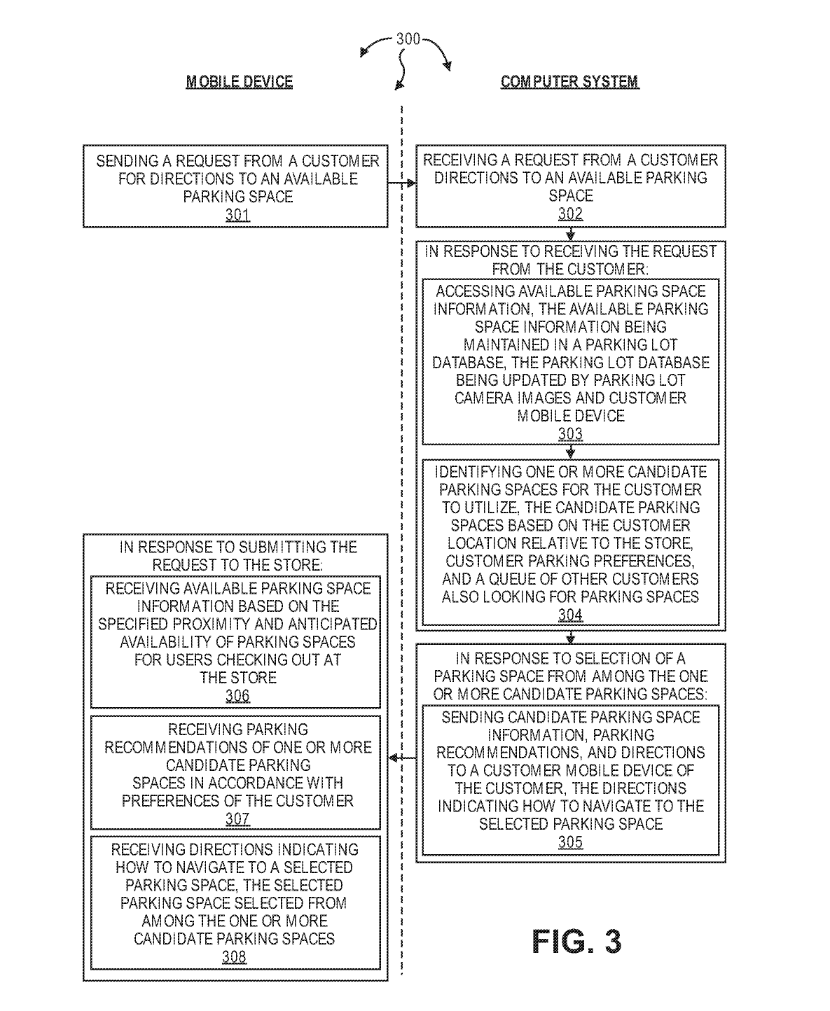

FIG. 3 illustrates a flow chart of an example method 300 for navigating a customer to a parking space. Method 300 will be described with respect to the components and data of computer architecture 200.

Method 300 includes sending a request from a customer for directions to an available parking space (301). For example, mobile device 211 (or vehicle navigation system 212) can send parking direction request 221 from customer 291 to computer system 201. Parking direction request 221 can be a request for a parking space at a store location. As customer 291 is driving a vehicle to the store location, customer 291 can utilize mobile device 211 or vehicle navigation system 212 (e.g., through a corresponding application installed at mobile device 211 or at vehicle navigation system 212) to generate parking direction request 221.

As depicted, parking direction request 221 includes customer ID 223, vehicle location 224, store ID 225, customer preferences 226, and customer shopping list 227. Customer ID 223 can be used to identify customer 291. Vehicle location 224 indicates customer 291's proximity to the store location when parking direction request 291 is sent. In general, the parking lot of the store location that is in closest proximity to the customer vehicle can be assumed to be the store location where the customer is requesting a parking space. In some embodiments, the customer may identify a different store location at which to park, indicated by store ID 225.

In some embodiments, customer 291 may also specify customer preferences 226 indicating preferences for candidate parking spaces, such as, for example, a compact parking space, a space designated for wider vehicles, a space that is within 100 feet of the store location entrance, or a space designated for handicap vehicles, etc. Customer preferences 226 may have been previously specified in the customer mobile device 211, or in some embodiments, in the vehicle navigation system 212, or customer preferences may be specified during the time of request.

Additionally, in some embodiments, customer 291 may include customer shopping list 227 in parking direction request 221. Customer shopping list 227 can be a list of items specified on the mobile device that customer 291 wishes to purchase.

Method 300 includes receiving a request from a customer for directions to an available parking space (302). For example, computer system 201 can receive parking direction request 221 from mobile device 211 or vehicle navigation system 212. Additionally, computer system 201 can also receive parking direction requests 222 from mobile devices 213 or vehicle navigation systems 214. Mobile devices 213 and/or vehicle navigation systems 214 can be associated with customers 292.

Method 300 includes in response to receiving the request from the customer, accessing available parking space information, the available parking space information being maintained in a parking lot database, the parking lot database being updated by parking lot camera images and customer mobile devices (303). For example, in response parking direction request 221, database access module 203 can access parking space availability data 209 from parking lot database 204. Parking space availability data 209 can indicate whether a parking space is currently occupied, currently empty, and the duration of time a particular spot has been either occupied or empty.

In general, database access module 203 can be configured to update data in parking lot database 204, including parking lot maps 205. Each parking lot map 205 can be associated with a particular store location. Each parking lot map 205 can also contain details, for example, regarding parking lot layout relative to store location entrances, parking lot layout relative to adjacent streets and street entrances to the parking lot, locations of compact vehicle parking spaces, wider vehicle parking spaces, shopping cart collection stalls, handicap parking spots, RV and bus parking, and covered parking, etc.

Parking lot database 204 can also be configured to store customer info 206. For each of one or more customers, customer info 206 can contain customer ID 207 and, in some embodiments, customer preferences 208. For example, parking lot database 204 can utilize customer ID 207 to track which customer is occupying a particular space. Customer preferences 208 can include such information as whether a customer desires a compact parking space, a space designated for wider vehicles, a space that is within 100 feet of the store location entrance, or a space designated for handicap vehicles, just to name a few.

Parking lot database 204 can be configured to store updates regarding the status of parking spaces available in the parking lot. The updates can be utilized to update parking space availability data 209. For example, camera system 246 can be configured to monitor the parking spaces in a parking lot. Camera system 246 can provide camera data 242 to parking space availability module 202. The camera data can include, for example, still images, video images, color images, black or white images, and the like.

Parking space availability module 202 can utilize image processing routines to process camera data 242 and identify which parking spaces are currently utilized and which camera spaces are currently available. Parking space availability module 202 can also process camera data 242 to identify customers just leaving vehicles, indicating that a vehicle is likely to be parked for a longer period of time, and customers that are returning to vehicles, indicating that a parking space may shortly be available. Camera data 242 can also be used to identify brake lights (red) and reverse lights (white) which can increase confidence that the identified parking space will be available shortly. Furthermore, camera data 242 can be used to identify aisles that are congested in the parking lot, and aisles that are moving freely. Parking space availability module 202 can use the processed data results to update parking space availability data 209 contained in parking lot database 204.

In some embodiments, other sensors can also be utilized to update parking space availability 209 contained in parking lot database 204. For example, sensor system 247 can provide sensor data 243 to parking space availability module 202. Sensor system 247 can be configured to detect the presence of a vehicle in a parking space. Sensor system 247 can include, for example, sensors embedded in the parking lot pavement, such as inductance sensors utilized at traffic lights, light sensors, such as safety sensors utilized by automatic garage doors, RFID sensors, such as sensors utilized by vehicles with express passes for toll roads, and the like. Parking space availability module 202 can use sensor data 243 to update parking space availability data 209 contained in parking lot database 204.

Mobile devices 245 can also be utilized to update the status of parking space availability in a parking lot. For example, customers 293 can have mobile devices 245 in their possession. Parking space availability module 202 can be configured to track the locations and paths of customers 293 utilizing a track location feature found within the customer mobile devices 245, such as a Global Positioning System (GPS) feature. For example, mobile devices 245 can transmit mobile device data 241 to parking space availability module 202. Mobile device data 241 can contain the locations and paths of customers 293.

Parking space availability module 202 can utilize mobile device data 241 to identify that a customer 293 is moving toward the location where their vehicle is parked. Parking space availability module 202 can estimate the time at which the customer 293 is to return to their vehicle and leave their parking space. Parking space availability module 202 can flag the parking space as a candidate parking space available for other customers that are to arrive at to the store location around or shortly after the estimated time.

Parking space availability module 202 can also utilize customer activity within the store location to determine which parking spaces may soon become available. For example, parking space availability module 202 can receive POS data 244 from POS systems 249 and/or mobile devices 248 in the store location. POS systems 249 and mobile devices 248 can be used to identify customers 294 who may be in the checkout procedure. Mobile devices 248 and POS systems 249 can send POS data 244 to parking space availability module 202 indicating the location of customers in the checkout process and the rate at which they are proceeding through the checkout process. POS data 244 can be used to estimate when the customers may be returning to their vehicles. Parking space availability module 202 can use POS data 244 to update parking lot database 204 indicating parking spaces that may be candidate spaces based on customers 294 returning to their vehicles after check out.

Parking space availability module 202 can also be utilized by a customer returning to his or her vehicle after visiting the store location. For example, parking space availability module 202 can provide directions for a customer to return to their parking space. Providing return directions makes it simpler and more efficient for a customer to find their way back to their vehicle. Providing return directions can be particularly useful in larger parking lots, in crowded parking lots and/or in multi-level parking structures.

Parking space availability module 202 can also use POS data 244 to indicate average wait times at POS systems 249, including POS systems 249 having shorter wait times. Parking space availability module 202 can utilize POS data 244 to indicate to customers how busy a store location is estimated to be at the time the customers have selected to visit the store location. Parking space availability module 202 can suggest other times that may be less busy and/or other store locations that may be less busy. Parking space availability module 202 can also indicate to customers which POS systems the customer can utilize to minimize their wait time while checking out.

Method 300 includes in response to receiving the request from the customer, identifying one or more candidate parking spaces for the customer to utilize, the candidate parking spaces based on the customer location relative to the store location, customer parking preferences, and a queue of other customers also looking for parking spaces (304). For example, in response to parking direction request 221, parking space availability module 202 can identify candidate parking spaces 262 for customer 291. Parking space availability module 202 can identify candidate parking spaces 262 based on the location of customer 291 relative to the store location, customer preferences 226 and/or 208, and a queue of other parking space requests.

Parking space availability module 202 can identify customer 291 as being in closest proximity to the store location based on vehicle location information 224. Parking space availability module 202 can utilize database access module 203 to query parking lot database 204 for parking space availability data 209. From parking space availability data 209, parking space availability module 202 can identify available parking spaces at the store location. From available parking spaces, parking space availability module 202 can in turn identify candidate parking spaces 262 for customer 291.

In one aspect, parking space availability module 202 selects an appropriate (optimal) parking space for customer 291 from among candidate parking spaces 262. An appropriate (optimal) parking space may be an available parking space that is closest to the main entrance of the store location. In some embodiments, parking space availability module 202 can also utilize customer preferences 226, customer shopping list 227, and or customer preferences 208 (resident in parking lot database 204) to further refine selection of an appropriate (optimal) parking space for customer 291.

For example, if customer shopping list 227 includes items that are found primarily in a garden center, parking space availability module 202 can identify candidate parking spaces that are near the garden center entrance. Parking space availability module 202 can then select an appropriate (optimal) parking space form among the candidate parking spaces near the garden center entrance. Parking space availability module 202 can also consider customer preferences 226 and/or 208 when identifying candidate parking spaces and selecting an appropriate (optimal) parking place for customer 291.

Accordingly, in general, and on an ongoing basis, parking space availability module 202 can process a list of customers needing parking spaces, their location relative to a store location, and in some embodiments their preferences and their shopping lists. Parking space availability module 202 can compare the list of customers requesting spaces to the list of spaces that are currently available and the spaces that are to become available. Parking space availability module 202 can identify candidate spaces and select an appropriate (optimal) parking space for each customer that issued a parking direction request.

For example, several customers may be en route to a particular store location concurrently. Each customer may issue a parking direction request indicated (e.g., parking direction request 221 and parking direction requests 222). The requests can be issued at different times as needs for parking spaces arise. Each parking direction request can include the location of the customer vehicle at the time of the request (e.g., vehicle location 224). Customers may be within different proximities of the particular store location when parking direction requests are submitted. Parking space availability module 202 can calculate estimated arrival times for the various customers and determine an order for assigning parking spaces. In some embodiments, parking space availability module 202 can also utilize customer preferences (e.g., 226) and/or customer shopping lists (e.g., 227) to facilitate candidate parking space identification and appropriate (optimal) parking space selections for the requesting customers.

Parking space availability module 202 can continually monitor parking space needs relative to parking space availability data 209 and make parking space assignment updates as appropriate. For example, parking space availability module 202 can estimate that a customer is leaving a store location and moving toward their vehicle. Parking space availability module 202 can determine that their parking space may be available in approximately three minutes. Based on availability of the parking space in three minutes, parking space availability module 202 can identify various candidate parking spaces for customers.

However, parking space availability module 202 may subsequently detect that the customer's movement toward their vehicle has stopped. As such, parking space availability module 202 can infer that their parking space is no longer to become available in approximately three minutes. Based on this change in circumstances, parking space availability module 202 can update various candidate parking spaces for customers.

Subsequently, parking space availability module 202 can again detect that the customer has again started moving again toward their vehicle. Based on this further change in circumstances, parking space availability module 202 can again update various candidate parking spaces for customers.

Method 300 includes in response to selection of a parking space from among the one or more candidate parking spaces, sending candidate parking space information, parking recommendations, and directions indicating how to navigate to a selected parking space (305). For example, parking space availability module 202 can send recommended parking space 261, parking directions 219, and candidate parking spaces 262 to mobile device 211 and/or vehicle navigation system 212. Parking space availability module 202 can select recommended parking space 261 from among candidate parking spaces 262. Parking space availability module 202 can select recommend parking space 261 based on customer preferences 226 and/or 208.

Parking directions 219 can indicate directions from the current customer location (as indicated by vehicle location 224) to recommended parking space 261. Parking directions 219 can include, for example, instructions detailing how long the customer should stay on his/her current street, how soon the customer should plan on turning, which direction (right or left) that the customer should turn, which parking lot aisle the customer should turn down, to reach recommended parking space 261.

Parking space availability module 202 can track the progress of customer 291 and compare customer 291's estimated time of arrival to the availability of recommended parking space 261. Parking space availability module 202 can update parking directions 219 to another of the candidate parking spaces 262 if it is determined that customer 291 has deviated from parking directions 219 and/or if the identified candidate parking space has changed due to a change in conditions at the store location parking lot. In some embodiments, GPS navigation can be used to navigate customer 291 to parking space 261 based on parking directions 291. Within the store location parking lot, sensors, such as, camera sensors, RFID sensors, and the like, can be used to navigate 291 to parking space 261 based on parking directions 219.

In response to submitting the request to the store location, method 300 includes receiving available parking space information based on the specified proximity and anticipated availability of parking spaces for users checking out at the store location (306). For example, mobile device 211 (or vehicle navigation system 212) can receive candidate parking spaces 262 from parking space availability module 202.

In response to submitting the request to the store location, method 300 includes receiving parking recommendations of one or more candidate parking spaces in accordance with preferences of the customer (307). For example, mobile device 211 (or vehicle navigation system 212) can receive recommended parking space 261 from parking space availability module 202.

In response to submitting the request to the store location, method 300 includes receiving directions indicating how to navigate to a selected parking space, the selected parking space selected from among the one or more candidate parking spaces (308). For example, mobile device 211 (or vehicle navigation system 212) can receive parking directions 219 to recommended parking space 261 from parking space availability module 202 Parking directions 219 can be in a visual format and/or audio format, being displayed and/or vocalized on the customer mobile device 211 (or vehicle navigation system 212).

Once the customer 291 has parked in a parking space (e.g., in recommended parking space 261 or in another of candidate parking spaces 262), customer 291 can indicate the parking space to availability module 202. The indication can include the time customer 291 parked and the location/identification of the utilized parking space. The parking space location and/or number can also be stored in the customer mobile device 211 for the customer 291 to provide directions for returning to the utilized parking space. In some embodiments, mobile device 211 can automatically indicate a utilized parking space to parking space availability module 202. In other embodiments, parking lot sensing systems such as camera system 246 or sensor system 247 can indicate a utilized parking space to parking lot availability module 202.

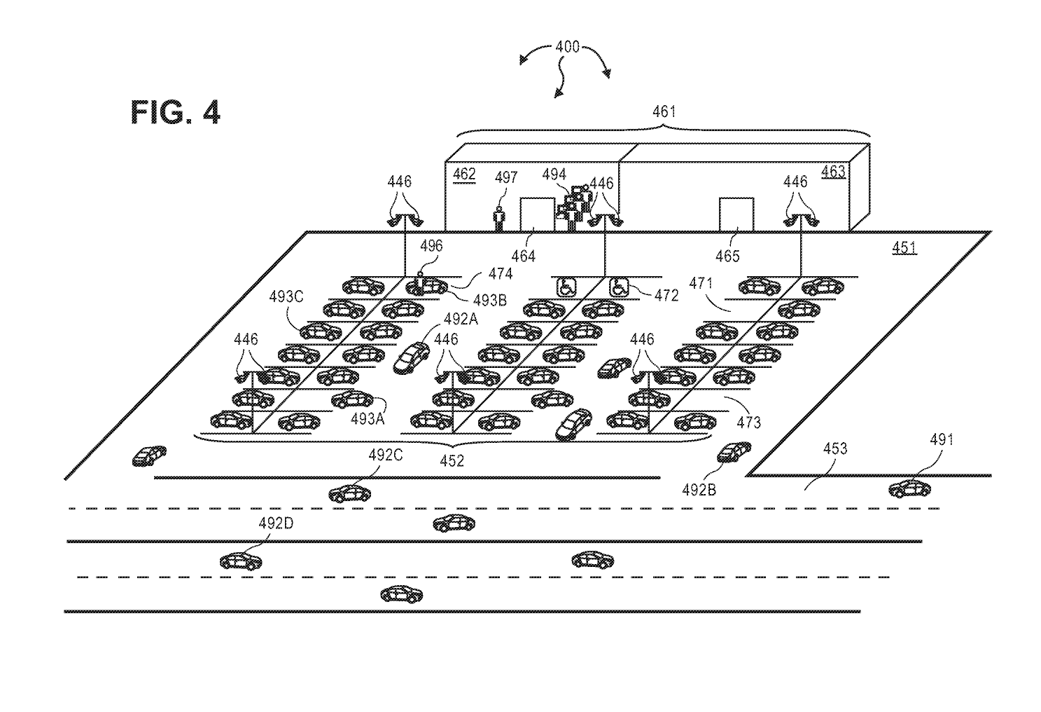

FIG. 4 illustrates an example parking navigation scenario 400. As depicted, store 461 includes a parking lot 451 which contains parking spaces 452. Parking lot 451 can be accessed via roadway 453 (and possibly also via other roadways). Store 461 includes a grocery section 462 and a department store section 463. Entrance 464 is closest to the grocery portion 462 and entrance 465 is closest to the department store section 463.

A customer 491 traveling on roadway 453 can utilizes a mobile device (not shown) or a vehicle navigation system (not shown) to request directions to a parking space in parking lot 451. The parking request is transmitted to a central computer system (not shown). For example, customer 491 can have an application loaded on their mobile device. The mobile application can be configured to receive a parking navigation request from customer 491 indicating that customer 491 is desirous of parking directions to a parking space in parking lot 451. The parking navigation request can be transmitted to the central computer system and include a present location and anticipated path of customer 491 to parking lot 451. Additional customers 492A, 492B, 492C, 492D, etc. can also submit parking navigation requests (either concurrently or in a staggered fashion) to the central computer system.

The central computer system can receive parking navigation requests from customer 491 as well as customers 492A, 492B, 492C, and 492D.

The central computer system maintains a map or a layout of parking lot 451, including the location of the parking spaces 452. In general, camera system 446 as well as other sensor systems (not shown) can be utilized to identify whether or not a parking space is being occupied by a vehicle. The central computer system can also utilize the locations and probable paths of customer's returning to their vehicles to anticipate when parking spaces may be coming available. Additionally, the central computer system can track the progress of customers in checkout lines to anticipate when the customers in the checkout lines are expected to return to their vehicles.

For example, camera system 446 can monitor parking spaces 452 in parking lot 451 and transmit parking lot imagery to the central computer system. The central computer system can process the received imagery and identify the occupied spaces as well as vacant spaces 471 and 473. The central computer system can also use the camera imagery to identify that vehicle 493A is leaving a parking space. Identifying that vehicle 493A is leaving a parking space can be based on detecting brake lights (red) and/or reverse lights (white) on vehicle 493A.

The central computer system can also utilize the location and anticipated paths of customers leaving store 461 through communication with their mobile devices (not shown). For example, the central computer system can detect that customer 496 has arrived back at vehicle 493B in parking space 474 given the proximity of customer 496's mobile device to vehicle 493B. The central computer system can also detect customer 497 leaving store 461 and moving towards vehicle 493C based on the location of customer 497's mobile device. The central computer system can estimate the time customer 497 is to arrive at vehicle 493C by tracking the location and path of customer 497's mobile device.

The central computer system can also track the progress of customers 494 in the process of checking out. The central computer system can communicate with the mobile devices (not shown) of customers 494 or point-of-sale (POS) systems to identify customers 494 in the process of checking out. The central computer system can estimate an amount of time for each of customers 494 to progress through their respective checkout lines and exit store 461. The central computer system can use customer checkout data to estimate a time when the parking spaces utilized by customers 494 may become available.

Parking lot 451 can also include specialized parking places, such as, handicapped parking spaces 472 and RV parking spaces. The central computer system can be aware of the location of these specialized parking spaces

As such, the central computer system can identify parking spaces that are currently available and can estimate when other parking spaces are to become available. The central computer system can used this information to identify candidate parking spaces for customers in parking lot 451 and/or that are en route to store 461. For example, the central computer system can process parking requests from customers 491, 492A, 492B, 492C, and 492D. Each parking request can include the customers' current location and anticipated path to store 461.

The central computer system can process the customers' parking requests. From the customers' requests, the central computer system can identify the customer in need of a parking space first. The identified customer can be based on customers already in parking lot 451, customers in closer proximity to store 461, when customers are due to arrive at store 461, etc. For example, the central computer system can identify that customer 492A is in need of a parking space first, 492B is in need of a parking space second, 491 is in need of a parking space third, 492C is in need of a parking space fourth, and 492D is in need of a parking space fifth, etc. The central computer system can direct customer 492A to parking space 471 and can direct customer 492B to parking space 473. The central computer system can also direct customer 491 to parking space 474 in anticipation of customer 494B leaving.

In some embodiments, customer parking requests can also include customer parking preferences and/or customer shopping lists. The central computer system can utilize the customer preferences and/or shopping lists to further refine selection of appropriate (optimal) parking spaces for the customers. For example, customer 491 may indicate that a wide parking space is desired. The central computer system can accommodate customer 491 by providing customer 491 with directions to an RV parking space.

The central computer system can also consider a customer shopping list when selecting an appropriate (optimal) parking space. For example, a shopping list resident on the mobile device of customer 491 may include primarily grocery items. As such, the central computer system can attempt to identify a parking space for customer 491 that is closer to entrance 464.

The central computer system can continually monitor the status of parking spaces 452 and the progress of the customers who requested parking spaces to update candidate parking space assignments as needed. As candidate parking spaces are identified, the central computer system can send directions to customer mobile devices (or vehicle navigation systems). Directions can be in an audio and/or visual format. The customers can receive parking directions from the central computer system. The customers can view and/or listen to directions at their mobile device and/or vehicle navigation system.

Accordingly, parking navigation enables a person to navigate to an appropriate parking space as they arrive at a store location parking lot and enables the person to navigate back to their vehicle in the store location parking lot when they exit the store location.

In other aspects, components utilized for parking navigation can include: (1) store area maps with parking spaces identified, (2) parking lot cameras or other sensors which can detect the presence of a car in each parking space, (3) the association of parking space images or sensor data with parking spaces identified on the store map, (4) the identification of aisle ways for navigation and also for association with camera imagery, (5) customer smart devices utilizing loaded applications for purposes of transmitting and receiving communications, (6) a store network available for customer use, and (7) a central computer to process the imagery and route the customers to the candidate parking spaces.

Store camera imagery and/or other sensor data can be transmitted to central computer. The central computer is capable of image processing and/or processing sensor data to detect the presence of vehicle in a parking space. In one aspect, parking spaces have painted identifying labels to assist with the image recognition process. A painted visible label can indicate a free space and a hidden label can indicate a filled space. Smart pavement sensors, or other sensors, can also be used to detect the presence of a vehicle without the use of a parking lot camera.

Customers can utilize smart devices, such as mobile phones, with geo-location capabilities. The geo-location capabilities can be more accurate than GPS tracking alone and can be configured to convey customer location information through the use of LED smart lights. Customers can utilize applications resident at mobile devices or login into the store website directly, to configure their preferences. Customer preferences may include, for example, if the customer desires a parking space reserved for handicapped customers or a parking space designated for oversize vehicles. Customers can also utilize applications to convey shopping list information as part of the parking navigation request. The central computer system can use shopping list information to determine the entrance in closest proximity to the items on the customer's shopping list. If a shopping list is not available or resident on the customer's mobile device, the system can default to the parking space closes to any entrance.

As the central computer system receives customer parking requests and associated preferences, the central computer system can evaluate possibilities for an appropriate (optimal) parking space. The central computer can select the optimal spot for the customer based upon their parking preferences (e.g., if they desire a handicapped and their shopping list.

In addition to monitoring whether a vehicle is in a parking space or not, the central computer system can also determine other parking lot information. The central computer system can determine the number of vehicles waiting in aisles for a parking space and the number of vehicles in the process of leaving the store. The central computer system can also identify customers getting back in their vehicles as well as identifying brake lights and reverse lights on vehicles. Identification of leaving vehicles leaving can increase the confidence that parking spaces are to be available to other customers. The central computer system can anticipate a vehicle exiting a parking space and prepare to include this soon to be available space in a list of candidate parking spaces.

Once candidate parking spaces are identified, the central computer system can transmit navigation directions to the appropriate (optimal) candidate parking space to the customer's smart device. The directions can be step-by-step instructions guiding the customer to the appropriate aisle and space.

As the customer parks their vehicle, they can utilize their smart device to indicate to the central computer system that they have parked. For example, parking spaces can have labels similar to a QR code on a post in front of the parking space. The customer can scan and associate the label with their smart device. Alternately, stickers can be placed on the windshield or invisible ink labels can be placed on top of vehicles for the video cameras or other sensor systems to establish a vehicle's position and the customer associated with the vehicle. Windshield stickers can be similar to stickers utilized on toll roads. The labels can be acquired while the customer is in the store and affixed to the car for future visits. The customer can register the label information while in the store or online so that the central computer system knows which label is associated with which customer. The central computer system can then detect where a customer has parked their vehicle by tracking where the system directed the customer to park, utilizing the stickers on the windshield, the labels on top of the car, or by utilizing the geo-location capability on the mobile device when the customer has signaled via his/her mobile device that he/she has parked.

Upon exiting a checkout line, a customer can submit a request through their smart device to the central computer system for an indication of where their vehicle is parked. This can be accomplished by pressing a button on the smart device or through a voice command to the mobile app. The central system can then determine the route from the customer's current location to the location of the parked vehicle. The central computer system can return the route to the customer's smart device. The smart device can display a map of the customer's current location and the location where their car is parked.

The central computer system can anticipate a parking space becoming available based on a customer's location in a checkout line and/or as the customer is checking out at the register. Thus, the central computer system would not need to wait until the customer is in the parking lot. Anticipating parking space availability can be accomplished when a customer is a registered member of the store parking program and their car parking place was identified when they parked. The central computer system can also adjust the anticipated return time to the customer's vehicle by monitoring the customer's progress as they make their way back to their parked vehicle.

An advantage of the central computer system is that it is continually monitoring the progress of customers as they are in the checkout process. The central computer system can use the average speed of check out for a particular cashier or checkout line by calculating scans per hour or visits (receipts) per hour and the congestion of the queue. The central computer system can predict the fastest register queue line to enter. The calculation can be used for any register area such as grocery, tire and lube, general items, or pharmacy.

The central computer system can predict, based upon congestion of the total queues, if the selected shopping time is an expeditious time to shop or if the anticipated wait times for the customer submitting the parking request might be longer than average wait times. The estimated wait time can be based upon the queue length and the number of open queues. An average wait time can be estimated based upon the average scan time (where scan time is defined as the begin scan timestamp subtracted from the end scan timestamp).

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

1. A method for use at a computer system, the computer system including one or more processors and system memory, the method for navigating a customer to a parking space, the method comprising the processor:
receiving a customer request at the computer system from a device associated with a customer, the customer request requesting directions to an available parking space in a parking lot of a store, the customer being a customer of the store;
in response to receiving the customer request:
accessing available parking space information for the parking lot from a parking lot database, the parking lot database being updated by parking lot camera images, parking lot sensor data, and customer mobile devices; and
identifying one or more candidate parking spaces for the customer to utilize, the one or more candidate parking spaces identified based on the customer location relative to the store, customer parking preferences retrieved from the parking lot database, and a queue of other customers also looking for parking spaces; and
in response to selection of a parking space from among the one or more candidate parking spaces, transmitting directions from the computer system to the customer, the directions indicating how to navigate to the selected parking space from the customer location.

2. The method of claim 1, wherein identifying one or more candidate spaces for the customer to park comprises referring to a shopping list resident on the customer mobile device.

3. The method of claim 1, wherein identifying one or more candidate parking spaces for the customer comprises communicating with one or more mobile devices to anticipate that other customers in a checkout line are likely to be returning to their parked vehicles within a specified time period.

4. The method of claim 1, wherein transmitting directions to the customer comprises transmitting directions to a customer mobile device.

5. The method of claim 1, wherein transmitting directions to the customer comprises transmitting the directions to a vehicle navigation system.

6. The method of claim 1, wherein transmitting directions to the customer comprises transmitting the directions to in a visual format.

7. The method of claim 1, wherein transmitting directions to the customer comprises transmitting the directions in an audio format.

8. The method of claim 1, wherein accessing available parking space information comprises accessing data from a smart pavement sensor associated with each parking space in the parking lot.

9. The method of claim 1, accessing available parking space information comprises accessing data from an infrared sensor associated with each parking space.

10. The method of claim 1, further comprising transmitting the location of the selected parking space to a customer mobile device upon detecting the customer exiting the store.

11. The method of claim 1, further comprising transmitting the location of the selected parking space to a customer mobile device upon detecting the customer checking out at a Point-Of-Sale (POS) terminal.

12. The method of claim 1, further comprising identifying a vehicle as being associated with the customer by detecting a sticker in the windshield of the vehicle.

13. The method of claim 1, wherein accessing available parking space information comprises identifying a least congested pathway to the selected parking space.

14. The method of claim 1, wherein identifying one or more candidate parking spaces for the customer comprises identifying one or more candidate parking spaces based on parking preferences for the customer.

15. The method of claim 1, wherein identifying one or more candidate spaces for the customer comprises identifying one or more candidate spaces based on checkout lines with the shortest wait time.

16. The method of claim 1, wherein identifying one or more candidate spaces for the customer comprises providing an indication of store congestion based on one or more of: expected check out times and percentage of the parking lot being utilized, the indication being used by the customer to determine whether to shop at the store.

17. A method for use at a mobile device, the mobile device including one or more processors and system memory, the method for navigating a customer to a parking space, the method comprising the processor:
submitting a parking space request from the mobile device to a central computer system for a store, the parking space request requesting an available parking space in a parking lot of the store by automatically notifying the store when the customer is in route to the store and is within a specified proximity of the store; and
in response to submitting the request to the store, the mobile device:
receiving available parking space information from the central computer system based on the specified proximity and anticipated availability of parking spaces for users checking out at the store;
receiving parking recommendations of one or more candidate parking spaces from the central computer system in accordance with preferences of the customer; and
receiving directions indicating how to navigate to a selected parking space from the central computer system, the selected parking space selected from among the one or more candidate parking spaces.

18. The method of claim 17, wherein receiving available parking space information comprises receiving a visual map of available parking locations at the store.

19. The method of claim 17, wherein submitting a request for directions to an available parking space comprises submitting shopping list data resident at the mobile device.

20. A computer program product for use at a computer system, the computer program product for implementing a method for navigating a customer to a parking space, the compute program product comprising one or more computer storage devices having stored thereon computer-executable instructions that, when executed at a processor, cause the computer system to perform the method, including the following:
receive a customer request at the computer system from a device associated with a customer, the customer request requesting directions to an available parking space in a parking lot of a store, the customer being a customer of the store;
in response to receiving the customer request:
access available parking space information for the parking lot from a parking lot database, the parking lot database being updated by parking lot camera images, parking lot sensor data, and customer mobile devices; and
identify one or more candidate parking spaces for the customer to utilize, the one or more candidate parking spaces identified based on the customer location relative to the store, customer parking preferences retrieved from the parking lot database, and a queue of other customers also looking for parking spaces; and
in response to selection of a parking space from among the one or more candidate parking spaces, transmit directions from the computer system to the customer, the directions indicating how to navigate to the selected parking space from the customer location.
